(19) United States
(12) Patent Application Publication
(10) Pub. No.: US 2025/0178262 A1
(43) Pub. Date: Jun. 5, 2025

(54) PP-Containing-Post-Consumer-Reclaimed Shrink Films

(71) Applicant: Treofan Germany GmbH & Co. KG, Neunkirchen (DE)

(72) Inventor: Bertram Schmitz, Saarbrücken (DE)

(73) Assignee: Treofan Germany GmbH & Co. KG, Neunkirchen (DE)

(21) Appl. No.: 19/049,558

(22) Filed: Feb. 10, 2025

Related U.S. Application Data
(63) Continuation of application No. PCT/IB2024/051426, filed on Feb. 14, 2024.
(60) Provisional application No. 63/447,363, filed on Feb. 22, 2023.
(60) Provisional application No. 63/526,210, filed on Jul. 12, 2023.
(60) Provisional application No. 63/548,411, filed on Nov. 14, 2023.

(51) Int. Cl. B29C 48/22; B29C 48/00; B29C 48/08; B29C 48/21; B29C 48/27; B29K 23/00; B29K 105/00; B29K 105/26; B29L 7/00; B29L 9/00; B29L 31/00

(52) U.S. Cl. CPC B29C 48/22; B29C 48/0018; B29C 48/022; B29C 48/08; B29C 48/21; B29C 48/27; B29C 2948/92019; B29K 2023/12; B29K 2105/0085; B29K 2105/26; B29K 2995/0041; B29K 2995/0049; B29K 2995/0053; B29K 2995/0077; B29K 2995/0097; B29L 2007/008; B29L 2009/00; B29L 2031/744

(57) ABSTRACT

In one embodiment, the disclosure provides an oriented shrink film, which may include at least one layer (i.e., located in the core and/or tie layer(s)) comprising ≥about 5 wt. % through ≤about 95 wt. % of a combination of virgin polypropylene and post-consumer reclaimed polypropylene, wherein filter pressure of the post-consumer reclaimed polypropylene ≤about 50 bar/kg when using a 350-mesh filter on a COLLIN Teach Line Type FT-E20T extruder according to the method and settings in the description, and wherein the oriented shrink film has a shrink value of at least about 5% in at least one direction of orientation, i.e., machine, transverse, or both.

### REFERENCE TO RELATED APPLICATIONS

This is a continuation application from and that claims priority to PCT application PCT/IB2024/051426 filed Feb. 15, 2024, which claims priority to U.S. provisional application No. 63/447,363 filed Feb. 22, 2023, U.S. provisional application No. 63/526,210 filed on Jul. 12, 2023, and U.S. provisional application No. 63/548,411 filed on Nov. 14, 2023, all of which are incorporated by this reference in their entireties.

### BACKGROUND

Today, a huge amount of polypropylene scrap exists-as possible recycle-from various end-user applications. Other than downgrading, it is generally not possible to re-use recycled scraps as materials in biaxially oriented polypropylene (“BOPP”) films. Due to high technical and quality demands for raw materials used in filmmaking processes, use of recycled polypropylene, such as polypropylene post-consumer (“PP-PCR”) is difficult at best. Many plastics often impact the environment in detrimental ways, including, for instance, trash production and increased emission of carbon dioxide during processing. As a result, it is a great challenge to re-think the re-use of plastics to reduce the environmental impact of the waste residues resulting from the use of polypropylene in countless applications. In the ensuing pages, disclosed are example embodiments of BOPP shrink films comprising PP-PCR with selected quality properties for various packaging and labeling applications.

PP-PCR resins are available in the market, but because of the high number and/or percent of impurities, as well as high heterogeneity as well as the chemical and mechanical damages that the plastic suffers in its entire chain, i.e., from production to converting to end-user, the properties of those PP-PCR resins are generally poor, it has been impossible generally to re-use PCR in the demanding BOPP processes and films industry with any reliability.

Polymer-based plastics may be used today to manufacture a varied range of articles, including films, molded products, foams, bottles, bags, tissues, and more with particular characteristics. In relation to polypropylene, downgrading of the end-of-use scraps is possible for low-quality products having unpredictable properties.

Virgin polypropylene has many beneficial values in production and manufacture of polypropylene films. But, plastics often impact the environment in detrimental ways including trash production and increased emission of CO₂ during processing. So it is a great challenge for producers and end users to think about the use and re-use of plastics to reduce the environmental impact of the waste residues.

Post-consumer resins (PCR) are available in the market, but because of the high inhomogeneity of sources and the chemical and mechanical damages from which this plastic suffers in its entire chain (e.g., from production to waste), properties of those resins are generally poor and it is a challenge to re-use them in many applications that require particular standards.

### SUMMARY

In one example embodiment, disclosed is an oriented shrink film comprising at least one layer comprising ≥about 5 wt. % through ≤about 95 wt. % of a combination of virgin polypropylene and post-consumer reclaimed polypropylene, wherein filter pressure of the post-consumer reclaimed polypropylene ≤about 50 bar/kg when using a 350-mesh filter on a COLLIN

Teach Line Type FT-E20T extruder according to the method and settings in the description, wherein the oriented shrink film has a shrink value of at least about 5% in at least one direction of orientation. Filter pressure is around 0 bar/kg for with no impurities; contaminants/impurities are what increase filter pressure values. Filter pressure, itself, is a value measured by a machine available and usable by the ordinarily skilled artisan.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Various specific embodiments, versions and examples are described now, including exemplary embodiments and definitions that are adopted herein for purposes of understanding. While the following detailed description gives specific preferred embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “elastomer” is defined as a propylene-based or ethylene-based copolymer that can be extended or stretched with force to at least 100% of its original length, and upon removal of the force, rapidly (e.g., within 5 seconds) returns to its original dimensions.

As used herein, “plastomer” is defined as a propylene-based or ethylene-based copolymer having a density in the range of 0.850 g/cm³ to 0.920 g/cm³ and a DSC melting point of at least 40° C.

As used herein, “intermediate” is defined as the position of one layer of a multilayered film, wherein said layer lies between two other identified layers. In some embodiments, the intermediate layer may be in direct contact with either or both of the two identified layers. And/or in other embodiments, additional layers may also be present between the intermediate layer and either or both of the two identified layers.

As used herein, “substantially free” is defined to mean that the referenced film layer is largely, but not wholly, absent a particular component. In some embodiments, small amounts of the component may be present within the referenced layer as a result of standard manufacturing methods, including recycling of film scraps and edge trim during processing.

By “consist essentially of,” what is meant, for example, is that a particular film layer does not have any more than 1 wt. % or 2 wt. % or 3 wt. % or 4 wt. % or 5 wt. % of other polymers in the bulk material constituting the film layer's composition, but “consist essentially of” does not exclude the possibility that the particular film layer also has additives, such as anti-slip agents, anti-blocking agents, anti-oxidants, pigments, whitening agents, cavitation agents, etc. regardless of what polymers or other materials make up the additive(s).

As used herein, “about” means the number itself and/or within 5% of the stated number. For instance, with about 5%, this means 5 and/or any number or range within the range of 4.75 to 5.25.

Disclosed are methods, films, and labels related to the use of PCR in MOPP and/or BOPP-shrink films and labels. Shrink packaging, for example, may start from a pouch made of a shrink film into which goods are introduced, followed by welding or other securing method, and then shrinking in an oven. After passing through the shrink oven, the goods are packed tightly in the film package, optionally without folds. Similarly, shrink labels (i.e., also a “film” at least for purposes of this disclosure) may be wrapped around a container, and after shrinkage in a shrink oven, the label is secured to the packaging container, optionally in a fold-free form.

To satisfy optical needs for the film packaging and labeled containers, the shrink of the films must exceed a given shrink value and shrink at least substantially homogenously. Furthermore, the disclosed shrink films have a low deviation of the shrinkage values in the machine-and transverse-direction of the monoaxially or biaxially oriented film. Large deviations in shrinkage values mean more wrinkles, poorer optics, poorer tensile strength, and less homogeneity as compared to films having small deviations in shrinkage values.

Surprisingly, with films using virgin PP in combination with PP-PCR(s) in the base and/or tie layer(s) in two, three, four, or five-layered films, with either a filter pressure value at about 50 bar/kg or below when using a filter web having 350 mesh (i.e., 40 μm pore size) or a filter pressure value at about 500 bar/kg or below when using a filter web having 500 mesh (i.e., ˜30 μm pore size), it was possible to produce PCR-PP-containing shrink films in the tenter process (i.e., biaxially oriented) providing high shrink values and low deviation of the shrink values in machine and transversal directions. Filter pressure values ≥50 bar/kg produce films with more film breaks, quality issues, and are generally commercially unacceptable films, and this is why this disclosure teaches use of 50 bar/kg or below as its surprisingly possible to make upgraded products therefrom instead of relegating use into a downgraded product or not used at all, i.e., garbage. As a result, this invention solves a problem by improving the lifecycle (i.e., birth to bin) of PCR-PP.

Also it was surprisingly found that the foregoing disclosed PP-PCR films, which used those above-stated filter pressure values, could be produced in economic scale, as further explained below, even when the PCR shows a filter pressure increase at a mesh above the film's final thickness, and was several times higher compared to standard BOPP grades used in BOPP production today. The filter pressure, itself, may serve as indicator of the contamination of the PCR grades selected to produce BOPP-shrink films.

Further still, it was surprisingly found that using these PCR grades resulted in “stable production” of BOPP-shrink films down to a film thickness lower than the filter pore size. Even when the filter pressure of the PCR is significantly higher than the filter pressure of the virgin polypropylene resin, it is still possible to produce BOPP-shrink films as disclosed herein. Surprisingly, shrink films containing post-consumer reclaim having low filter pressure, as above-described, showed homogenous shrink values with a low deviation of shrinkage. Due to the low haze values, the shrink films can be used in high-quality packaging applications that demand optical quality.

In various embodiments, PCR-containing PP shrink films and labels, i.e., “films,” may be mono- or co-extruded two-, three-, four-, five-layered, or more as just mentioned. And, reclaimed-PP-containing films may have reclaimed-PP in the base and/or tie layer(s) as just mentioned.

In addition to the PP-PCR, the base layer and/or tie layer(s) of the film also may contain resin(s), generally in an amount from about 1 to 20% by weight, preferably from about 1 to 15% by weight, more preferably from about 2 to 10% by weight, based on the weight of the base-or tie layer. Optionally, the resin(s) may be in a masterbatch or other type of solution, but the reported ranges herein are for the % of resin, itself, for inclusion in a particular layer. Preferred resins are low-molecular-weight resins, particularly hydrocarbon resins. The hydrocarbon resins may be partially or fully hydrogenated. Suitable resins are basically synthetic resins or resins of natural origin. It has proven particularly advantageous to employ resins having a softening point of about ≤180° C. (measured in accordance with DIN 1995-U4 or ASTM D3461), preferably those having a softening point from about 25° to 180° C., more preferably from about 60° to 150° C. (and/or any other range from about 25° to 180° C. within being pedantic so as to write out each possible range). The resin can be incorporated into the film in form of granules or liquids or in the form of a masterbatch, which is introduced into the extruder (for example a single-screw or cascade extruder). Examples of conventional masterbatches are those containing from about 30 to 70% by weight, preferably about 50% by weight, of propylene or propylene copolymer and/or terpolymer and from about 70 to 30% by weight, preferably about 50% by weight, of hydrocarbon resin. The data in % by weight are related to the total weight of propylene polymer and hydrocarbon resin.

In various example embodiments, PCR-containing films and labels had at least one layer comprising, consisting essentially of, or consisting of a PP-PCR polymer composition or combination thereof, wherein its reclaimed-PP content may vary from greater than or equal to about 5 wt. % through greater than or equal to about 95 wt. %—and any range in between that minimum and maximum without reciting each and every possible range, e.g., about 6 wt. % to about 12 wt. %, about 23 wt. % through about 67 wt. %, etc.—in combination with: (1) a virgin-PP-containing polymer resin content varying from greater than or equal to about 5 wt. % through greater than or equal to about 95 wt. %—and any range in between that minimum and maximum without reciting each and every possible range; and (2) optionally, additives, such as those named later in this disclosure.

The virgin PP-containing polymer may be selected from PP homopolymers (e.g., iPP, but not sPP), PP copolymers, and combinations thereof. And in some embodiments, the entire film excludes syndiotactic polypropylene.

The reclaimed-PP-containing films and labels resulted in stable productions, wherein a “stable production” means no web breaks on a BOPP tenter manufacturing tenter line run anywhere from 50 through 600 m/min at a temperature from 80 through 180° C., with a web width anywhere between 1.5 through 10 m, over a time period of 1.5 h.

### Measurements

### Haze

Haze is measured conform to ASTM-D-1003.

### Mechanical Values

Youngs/Elasticity Modulus and Tensile Strength were measured conform to EN ISO 527-1.

### Gloss

Gloss is measured on the treated conform to ASTM D2457 at angle of 60°.

### Shrink

The longitudinal and transverse shrinkage values refer to the respective linear length of the foil (longitudinal L0 and transverse Q0) before the shrinking process. The longitudinal direction is the machine direction; the transverse direction is defined accordingly as the direction perpendicular to the machine direction. The test piece having dimensions 10 cm×10 cm is shrunk in a circulating air oven at a temperature of 135° C. for 7 minutes. Then, the remaining linear lengths of the test piece are again determined lengthwise and transversely (L1 and Q1). The difference between the measured linear lengths relative to the original lengths L0 and Q0 is then multiplied by 100 and expressed as the shrinkage in a percentage.

$$SL : Lengthwise shrinkage [ \% ] = 100 \times ( L 0 - L 1 ) / ( L 0 ) [ \% ]$$

$$ST : Transverse shrinkage [ \% ] = 100 \times ( Q 0 - Q 1 ) / ( Q 0 ) [ \% ]$$

This method of determining lengthwise and transverse shrinkage corresponds to DIN 40634.

### Shrink Deviation

3 samples (10 cm×10 cm) were taken over the width in transversal of the produced film. One sample 50 cm away from the left border, one sample 50 cm away from the right border and one sample in the middle of the reel.

Such samples were taken 3 times in length direction, with a distance of 3 meters in length direction, of the sample reel. So that finally nine samples were taken. These samples were used to determine the shrink value according to the formula for standard deviation:

$$Dev . ST = \sqrt{\frac{{\sum }_{n} {( {ST}_{n} - \overline{ST} )}^{2}}{n - 1}}$$

Where STₙ (with n=9) are the shrink values measured in transversal direction, S̅T̅ is the average of the nine shrink values measured in transversal direction

$$Dev . SL = \sqrt{\frac{{\sum }_{n} {( {SL}_{n} - \overline{SL} )}^{2}}{n - 1}}$$

Where SLₙ (with n=9) are the shrink value measured in transversal direction, S̅L̅ is the average of the nine shrink values measured in transversal direction.

### Filter Pressure

A COLLIN Teach Line Type FT-E20T extruder was used in measuring filter pressure increase of the reclaimed PP-PCR grades. Granular reclaimed-PP was melted in the extruder, homogenized, and conveyed. The gear pump conveyed the melt at a constant throughput through a sieve, having different mesh sizes, and filter. The contaminants in the reclaimed-PP that are larger than the meshes of the sieve are retained, and, thereby, create an increase in pressure before the filter. The pressure curve from the beginning to the end of the filter test is recorded by means of the evaluation software and the pressure increase is recorded over time. The pressure increase is directly related to the number and size of the retained contaminants in the reclaimed-PP, i.e., contamination/particle size distribution. To state the foregoing discussion by a formula:

$$Teach Line Type FT - E20T FPI = ( Pmax - Ps ) / W$$

$$FPI = Filter pressure increase [ stated in bar / kg ]$$

$$Ps = Initial pressure at the beginning of the experiment$$

$$Pmax = maximum pressure detected after extrusion of one kg PCR through the filter$$

$$W = Weight of extruded polymer$$

The settings used for the COLLIN Teach Line Type FT-E20T extruder were:
Speed Gearpump: 50 Upm
Extruder speed: 50 Upm
Extruder temperature: Zone 1:200°° C., Zone 2-6:230° C.
Filter size (flow through area): 615 mm²
   As filter four different Metal wire mesh filter discs, available from HAVER & BOECKER OHG 59302 Oelde Germany, are used with 100 mesh up to 500 Mesh.

### Raw Materials

### PCR-Grades

Post Consumer Reclaim Nr. 1 (N1): rPPH03GR is a commercial available Post Consumer Reclaim (PCR) supplied by company TOTAL for various application.

Post Consumer Reclaim Nr. 2 (N2): MOPRYLENE® is a commercial available PCR supplied by company Morssinkhof for various application.

Post Consumer Reclaim Nr. 3 (N3): rPP1003 is a commercial available PCR-Masterbatch supplied by company Ineos. The Masterb contains 60% of post-consumer recycled material.

TABLE 1
Filter pressure results related to the PCR-grades and Polypropylene grades used

| | | | | | | | |
|---|---|---|---|---|---|---|---|
| | | | | Standard | Total | Morssinkhof | INEOS |
| | | | | hPP | rPPH03GR | MOPRYLENE ® | rPP1003 |
| | | | | Moplen | (N1) | (N2) | (N3) |
| | Pore | Filter | | HP525J | No stable | No stable | Stable |
| Source | Size | mesh | PCR-Grade | (virgin PP) | production | production | production |
| Filtertype | μm | Mesh | Performance | bar/kg | bar/kg | bar/kg | bar/kg |

| | | | | | | |
|---|---|---|---|---|---|---|
| SPW 250 | ~150 | 100 | — | 2.4 | 1.2 | — |
| SPW 125 | ~75 | 200 | — | 60.8 | 4 | 0.1 |
| SPW 63 | ~40 | 350 | — | 137 | 125.9 | 9.3 |
| DTW 45 S | ~30 | 500 | <1 | 1550 | 1375 | 53 |

### HCR Resin

As HCR resin, POLYBATCH® CPS 601 supplied by LyondellBasell may be used used. It is an HCR masterbatch containing 60% of HCR and 40% homopolymer PP. Other HCR resin(s) may be used instead, and the examples disclosed herein are in no way limited to CPS 601, masterbatches, or both. For example, in various embodiments, the disclosed oriented films may have at least one layer having ≥about 5 wt. % through ≤about 95 wt. % of a combination of virgin polypropylene and post-consumer reclaimed polypropylene, in addition to ≤about 20 wt. % hydrocarbon resin(s). In other example embodiment, such oriented films may include at least two or three of such at least one layers, wherein each of such at least one layers may further include hydrocarbon resin(s). And, in some example embodiments, one or more of such at least one layers may include hydrocarbon resin(s) in a masterbatch, such as hydrocarbon resin(s) in combination with polypropylene, which are in the form of homopolymers, copolymers, terpolymers, or combinations thereof.

### Propylene Homopolymer (Base & Tie Layer(s))

As polypropylene, the medium flow homopolymer Moplen HP525J supplied by LyondellBasell is used. Other PP(s), including copolymers and terpolymers (but excluding sPPs in various example embodiments), may be used instead, and the examples disclosed herein are in no way limited to HP525J, masterbatches, or both.

Copolymer and/or Terpolymer (Skin Layer(s)

As terpolymer, ELTEX® P KS385 supplied by INEOS is used. This INEOS masterbatch product contains antiblocking agent and supplies sealing properties to the film. Other terpolymers(s) and/or copolymers, such as PBTs and/or EPs, may be used instead, and the examples disclosed herein are in no way limited to P KS385, masterbatches, or both.

### Example Embodiments

Below are examples of PCR-containing films and labels. In Table 2, presented are compositions of different PCR films, thickness, and the result of the production trial, means if it was possible to produce a film or if there was no possibility of continuous production continuous production.

TABLE 2
Composition of the examples and related mechanical values and process stability

| | | X % | X % | | | E- | E- | Tensile | Tensile | |
|---|---|---|---|---|---|---|---|---|---|---|
| | | PCR | PCR | | Film | modulus | modulus | strength | strength | |
| | PCR | Base | Tie | X % | Thickness | MD | TD | MD | TD | Stable |
| Example | Grade | Layer | Layers | HCR | μm | N/mm² | N/mm² | N/mm² | N/mm² | Production? |
| Reference 1 | — | — | — | 6 | 21 | 2167 | 4297 | 164 | 261 | Yes |
| Reference 2 | — | — | — | 10 | 16 | 2372 | 3623 | 192 | 188 | Yes |
| Example 1 | Recl. N3 | 40 | 0 | 6 | 21 | 2176 | 3961 | 173 | 241 | Yes |
| Example 2 | Recl. N3 | 33 | 33 | 6 | 21 | 2215 | 3969 | 172 | 235 | Yes |
| Example 3 | Recl. N3 | 40 | 0 | 6 | 16 | 2456 | 3867 | 178 | 220 | Yes |
| Example 4 | Recl. N3 | 33 | 33 | 10 | 21 | 2215 | 3546 | 182 | 237 | Yes |
| Example 5 | Recl. N3 | 40 | 0 | 10 | 21 | 2154 | 3487 | 186 | 234 | Yes |
| Example 6 | Recl. N3 | 40 | 0 | 10 | 16 | 2275 | 3524 | 190 | 181 | Yes |
| Counter-Example 1 | Recl. N1 | 33 | 33 | 6 | 25 | 1773 | 2944 | 111 | 183 | No |
| Counter-Example 2 | Recl. N2 | 40 | 0 | 10 | 25 | 1698 | 2918 | 118 | 198 | No |

TABLE 3
Shows results achieved producing BOPP shrink film standard BOPP film containing
PCR in different concentrations in the base and/or tie layer(s)

| | | X % | X % | | | | Gloss @ | | | | |
|---|---|---|---|---|---|---|---|---|---|---|---|
| | | PCR | PCR | | Film | | 60° | | | | |
| | PCR | Base | Tie | X % | Thickness | | (Treated | Shrink | Shrink | Dev. | Dev. |
| Example | Grade | Layer | Layers | HCR | μm | Haze | Side) | SL % | ST % | SL/% | ST % |
| Reference 1 | — | — | — | 6 | 21 | 2.7 | 139 | 6.5 | 10.3 | 0.5 | 0.7 |
| Reference 2 | — | — | — | 10 | 16 | 2.1 | 138 | 10.1 | 14.2 | 0.3 | 0.4 |
| Example 1 | Recl. N3 | 40 | 0 | 6 | 21 | 2.6 | 139 | 6.9 | 10.5 | 0.4 | 0.6 |
| Example 2 | Recl. N3 | 33 | 33 | 6 | 21 | 2.7 | 139 | 7.3 | 10.2 | 0.2 | 0.3 |
| Example 3 | Recl. N3 | 40 | 0 | 6 | 16 | 2.8 | 139 | 7.2 | 10.4 | 0.4 | 0.4 |
| Example 4 | Recl. N3 | 33 | 33 | 10 | 21 | 2.0 | 139 | 10.3 | 14.4 | 0.3 | 0.4 |
| Example 5 | Recl. N3 | 40 | 0 | 10 | 21 | 2.6 | 139 | 10.7 | 15.1 | 0.3 | 0.3 |
| Example 6 | Recl. N3 | 40 | 0 | 10 | 16 | 2.1 | 139 | 10.2 | 14.8 | 0.4 | 0.4 |
| Counter-Example 1 | Recl. N1 | 40 | 0 | 6 | 25 | 13.0 | 110 | 6.7 | 10.2 | 2.2 | 2.5 |
| Counter-Example 2 | Recl. N2 | 40 | 0 | 10 | 25 | 12.0 | 109 | 7.1 | 10.9 | 2.3 | 2.7 |

### Reference 1

A 21 μm shrink film is produced on a BOPP production line in continuous mode using a 5-layer die/extrusion set-up and stable production conditions. Base and tie layers contained 10% of the HCR-PP-Masterbatch, so that they contain 6% of HCR in tie and base layers. Skin layers are equipped with a standard sealing terpolymer grade containing antiblock particles to prevent the final film from blocking.

The final film shown a good quality and shrink values of about 6% in MD and 10% in TD-direction. Shrink values showed low variation over the width and a standard deviation of 0.5% in MD and 0.7% in TD direction.

| Caster-Side | | Treatment (Corona or other type) |
|---|---|---|
| Skin layer 1 | 1 μm | 100% terpolymer |
| Tie Layer 1 | 2 μm | 90% PP Homo + 10% CPS 601 |
| Base Layer | 15.4 μm | 90% PP Homo + 10% CPS 601 |
| Tie Layer 2 | 2 μm | 90% PP Homo + 10% CPS 601 |
| Skin Layer2 | 0.6 μm | 100% terpolymer |

Waterbath

### Reference 2

Similar to reference 1, a 16 μm shrink film is produced on a BOPP production line in continuous mode using a 5-layer die/extrusion set-up and stable production conditions. As compared to reference 1, base and tie layers had HCR increased to 17% of the HCR-PP-masterbatch, so that they are containing 10% of HCR in tie and base layers. Skin layers are equipped with a standard sealing terpolymer containing antiblock particles to prevent the final film from blocking.

The final film showed good quality and shrink values of about 10% in MD and 14% in TD direction. Shrink values showed low variation over the width and a standard deviation of 0.3% in MD and 0.4% in TD direction.

| Caster-Side | | Treatment (Corona or other type) |
|---|---|---|
| Skin Layer 1 | 1 μm | 100% terpolymer |
| Tie Layer 1 | 2 μm | 83% PP Homo + 17% CPS 601 |
| Base Layer | 10.4 μm | 83% PP Homo + 17% CPS 601 |
| Tie Layer 2 | 2 μm | 83% PP Homo + 17% CPS 601 |
| Skin Layer2 | 0.6 μm | 100% terpolymer |

Waterbath

### Example 1

Similar to reference 1, a 21 μm shrink film is produced on a BOPP production using a 5-layer die/extrusion set-up. As compared to reference 1, 40% of PCR was added in the form of a 60% PCR-containing masterbatch (rPP1003 supplied by INEOS) in the base layer. HCR content was similar to Reference 1, 6% in base and tie layers. Skin layer formulation was similar to Reference 1. As for PCR, the rPP1003 supplied by Ineos was selected. The rPP 1003 showed a filter pressure result using the filter web SPW 63 about 10 bar/kg. See Table 1.

During production of the film, the line was running stable in continuous mode without web breaks.

The final film showed good quality and shrink values of about 7% in MD and 10.5% in TD direction. Shrink values showed low variation over the width and a standard deviation of 0.4% in MD and 0.6% in TD direction, i.e., a substantially homogenous shrink film like Examples 2-6 as well.

| Caster-Side | | Treatment (Corona or other type) |
|---|---|---|
| Skin Layer 1 | 1 μm | 100% terpolymer |
| Tie Layer 1 | 2 μm | 90% PP Homo + 10% CPS 601 |
| Base Layer | 15.4 μm | 65% rPP1003 + 25% PP |
| | | Homo + 10% CPS 601 |
| Tie Layer 2 | 2 μm | 90% PP Homo + 10% CPS 601 |
| Skin Layer2 | 0.6 μm | 100% terpolymer |

Waterbath

### Example 2

Similar to Example 1, a 21 μm shrink film is produced on the BOPP-line. As compared to Example 1, the film formulation contains 55% off the PCR Masterbatch in the base and tie layers. HCR content was similar to Reference 1, 6% in base and tie layers. Skin layer formulation was similar Reference 1. As for PCR and similar to Example 1, rPP1003 supplied by Ineos was selected. During production of the film, the line was running stable in continuous mode without web breaks.

The final film showed good quality and shrink values of about 7.3% in MD and 10.2% in TD direction. Shrink values showed low variation over the width and a standard deviation of 0.2% in MD and 0.3% in TD direction.

| Caster-Side | | Treatment (Corona or other type) |
|---|---|---|
| Skin Layer 1 | 1 μm | 100% terpolymer |
| Tie Layer 1 | 2 μm | 55% rPP1003 + 35% PP |
| | | Homo + 10% CPS 601 |
| Base Layer | 15.4 μm | 55% rPP1003 + 35% PP |
| | | Homo + 10% CPS 601 |
| Tie Layer 2 | 2 μm | 55% rPP1003 + 35% PP |
| | | Homo + 10% CPS 601 |
| Skin Layer2 | 0.6 μm | 100% terpolymer |

Waterbath

### Example 3

Similar to Example 1, a 16 μm shrink film is produced on a BOPP production using a 5-layer die/extrusion set-up. As compared to Reference 1, HCR content was similar, 6% in base and tie layers. Skin layer formulation was similar reference 1. As for PCR, the rPP1003 supplied by Ineos was selected.

During production of the 16 μm film, the line was running stable in continuous mode without web breaks.

The final film showed good quality and shrink values of about 7.2% in MD and 10.4% in TD-direction. Shrink values showed low variation over the width and a standard deviation of 0.4% in MD and 0.4% in TD direction.

| Caster-Side | | Treatment (Corona or other type) |
|---|---|---|
| Skin Layer 1 | 1 μm | 100% terpolymer |
| Tie Layer 1 | 2 μm | 90% PP Homo + 10% CPS 601 |
| Base Layer | 10.4 μm | 65% rPP1003 + 25% PP |
| | | Homo + 10% CPS 601 |
| Tie Layer 2 | 2 μm | 90% PP Homo + 10% CPS 601 |
| Skin Layer2 | 0.6 μm | 100% terpolymer |

Waterbath

### Example 4

Similar to Reference 1, a 21 μm shrink film is produced on a BOPP production using a 5-layer die/extrusion set-up. Similar to Example 1, 40% of PCR was added in form of a 55% PCR-containing masterbatch in the base and tie layers. As compared to Example 1, HCR masterbatch increased to 17% in the tie and base layers. Skin layer formulation was similar reference 1. As for PCR, the rPP1003 supplied by Ineos was selected.

During production of the film, the line was running stable in continuous mode without web breaks.

The final film showed good quality and shrink values of about 10.3% in MD and 14.4% in TD direction. Shrink values showed low variation over the width and a standard deviation of 0.3% in MD and 0.4% in TD direction.

| Caster-Side | | Treatment (Corona or other type) |
|---|---|---|
| Skin layer 1 | 1 μm | 100% terpolymer |
| Tie Layer 1 | 2 μm | 55% rPP1003 + 28% PP |
| | | Homo + 17% CPS 601 |
| Base Layer | 15.4 μm | 55% rPP1003 + 28% PP |
| | | Homo + 17% CPS 601 |
| Tie Layer 2 | 2 μm | 55% rPP1003 + 28% PP |
| | | Homo + 17% CPS 601 |
| Skin Layer2 | 0.6 μm | 100% terpolymer |

Waterbath

### Example 5

Similar to Reference 2, a 21 μm shrink film is produced on a BOPP production using a 5-layer die/extrusion set-up. Similar to Example 1, 40% of PCR was added in form of a 60% PCR-containing masterbatch in the base layer. As compared to Example 1, the HCR content increased by increasing the HCR-Masterbatch in tie and base layers to 17%. Skin layer formulation was similar reference 1. As for PCR, the rPP1003 supplied by Ineos was selected.

During production of the film the line was running stable in continuous mode without web-breaks.

The final film showed good quality and shrink values of about 10.7% in MD and 15.1% in TD direction. Shrink values showed low variation over the width and a standard deviation of 0.3% in MD and 0.3% in TD direction.

| Caster-Side | | Treatment (Corona or other type) |
|---|---|---|
| Skin Layer 1 | 1 μm | 100% terpolymer |
| Tie Layer 1 | 2 μm | 83% PP Homo + 17% CPS 601 |
| Base Layer | 15.4 μm | 58% rPP1003 + 25% PP |
| | | Homo + 17% CPS 601 |
| Tie Layer 2 | 2 μm | 83% PP Homo + 17% CPS 601 |
| Skin Layer2 | 0.6 μm | 100% terpolymer |

Waterbath

### Example 6

Similar to Example 5, a 16 μm shrink film is produced on a BOPP production using a 5-layer die/extrusion set-up. Similar to Example 1, 40% of PCR was added in form of a 60% PCR-containing masterbatch, i.e., CPS 601, in the base layer and about 10% of HCR in tie and base layers. As PCR, the rPP1003 supplied by Ineos was selected.

During production of the film, the line was running stable in continuous mode without web breaks.

The final film showed good quality and shrink values of about 10.2% in MD and 14.8% in TD direction. Shrink values showed low variation over the width and a standard deviation of 0.4% in MD and 0.4% in TD direction.

| Caster-Side | | Treatment (Corona or other type) |
|---|---|---|
| Skin Layer 1 | 1 μm | 100% terpolymer |
| Tie Layer 1 | 2 μm | 83% PP Homo + 17% CPS 601 |
| Base Layer | 10.4 μm | 65% rPP1003 + 18% PP |
| | | Homo + 17% CPS 601 |
| Tie Layer 2 | 2 μm | 83% PP Homo + 17% CPS 601 |
| Skin Layer2 | 0.6 μm | 100% terpolymer |

Waterbath

### Counter-Example 1

Similar to the references, produced was a shrink film on a BOPP production line using a 5-layer die/extrusion set-up and stable production conditions. As compared to Reference 1, 40% of the PCR supplied by Total (rPPH03GR) was added in the base layer. HCR content was similar to Reference 1, 10% of the HCR-PP masterbatch, so 6% of HCR in tie and base layers. Similar to Reference 1, skin layers were made of standard sealing Ineos terpolymer.

Unfortunately, this counter example did not produce a continuous film sample due to film breaks during production. So, the film thickness had to be increased to 25 μm. And despite this change, still no stable web production resulted.

The film samples showed poor quality and shrink values of about 6.7% in MD and 10.2% in TD direction. Shrink values showed low variation over the width and a standard deviation of 2.2 in MD and 2.5% in TD direction.

| Caster-Side | | Treatment (Corona or other type) |
|---|---|---|
| Skin layer 1 | 1 μm | 100% terpolymer |
| Tie Layer 1 | 2 μm | 90% PP Homo + 10% CPS 601 |
| Base Layer | 20.4 μm | 40% rPPH03GR + 50% PP |
| | | Homo + 10% CPS 601 |
| Tie Layer 2 | 2 μm | 90% PP Homo + 10% CPS 601 |
| Skin Layer2 | 0.6 μm | 100% terpolymer |

Waterbath

### Counter-Example 2

Similar to Counter-Example 1, produced was another shrink film of 21 μm and containing 6% HCR. As compared to Counter-Example 1, the PCR Total rPPH03GR was replaced by PCR-grade MOPRYLENE supplied by Morssinkhof in the base layer.

Also in this case, it was not possible to produce a continuous film sample due to film breaks during production. So, the film thickness was increased to 25 μm. And also after this change, no stable web production resulted, even taking into consideration that the filter pressure result of Moprylene using the filter web SPW 125 is about 4 bar/kg and more than ten times lower compared to Total PCR (60.8 bar/kg).

This film showed poor quality and shrink values of about 7.1% in MD and 10.9% in TD direction. Shrink values showed low variation over the width and a standard deviation of 2.3% in MD and 2.7% in TD direction.

| Caster-Side | | Treatment (Corona or other type) |
|---|---|---|
| Skin Layer 1 | 1 μm | 100% terpolymer |
| Tie Layer 1 | 2 μm | 90% PP Homo + 10% CPS 601 |
| Base Layer | 20.4 μm | 40% MOPRYLENE + 50% PP |
| | | Homo + 10% CPS 601 |
| Tie Layer 2 | 2 μm | 90% PP Homo + 10% CPS 601 |
| Skin Layer2 | 0.6 μm | 100% terpolymer |

Waterbath

### Polypropylene

In various embodiment of the disclosed films, the polypropylene (“PP”) used in the base layer may be a homopolymer, and in other embodiments may be a copolymer or terpolymer comprising from 60 wt. % or 70 wt. % or 80 wt. % or 85 wt. % or 90 wt. % or 95 wt. % or 98 wt. % or 99 wt. % to 100 wt. % propylene-derived units (and comprising within the range of from 0 wt. % or 1 wt. % or 5 wt. % to 10 wt. % or 15 wt. % or 20 wt. % or 30 wt. % or 40 wt. % C2 and/or C₄ to C₁₀ α-olefin derived units) and can be made by any desirable process using any desirable catalyst as is known in the art, such as a Ziegler-Natta catalyst, a metallocene catalyst, or other single-site catalyst, using solution, slurry, high pressure, or gas phase processes. Polypropylene copolymers and terpolymers are useful polymers in certain embodiments, especially copolymers of propylene with ethylene and/or butene, and comprise propylene-derived units within the range of from 70 wt. % or 80 wt. % to 95 wt. % or 98 wt. % by weight of the polypropylene. In any case, useful polypropylenes have a melting point (ASTM D3418) of at least 125° C. or 130° C. or 140° C. or 150° C. or 160° C., or within a range of from 125° C. or 130° C. to 140° C. or 150° C. or 160° C. A “highly crystalline” polypropylene is useful in certain embodiments, and is typically isotactic and comprises 100 wt. % propylene-derived units (propylene homopolymer) and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter-and intra-molecular order. Preferably, the polypropylene has a heat of fusion (Hf) greater than 60 J/g or 70 J/g or 80 J/g, as determined by DSC analysis. The heat of fusion is dependent on the composition of the polypropylene; the thermal energy for the highest order of polypropylene is estimated at 189 J/g that is, 100% crystallinity is equal to a heat of fusion of 189 J/g A polypropylene homopolymer will have a higher heat of fusion than a copolymer or blend of homopolymer and copolymer. Also, the polypropylenes useful herein may have a glass transition temperature (ISO 11357-1, Tg) preferably between −20° C. or −10° C. or 0° C. to 10° C. or 20° C. or 40° C. or 50° C. Preferably, the polypropylenes have a Vicat softening temperature (ISO 306, or ASTM D 1525) of greater than 120° C. or 110° C. or 105° C. or 100° C., or within a range of from 100° C. or 105° C. to 110° C. or 120° C. or 140° C. or 150° C., or a particular range of from 110° C. or 120°° C. to 150° C.

Preferably, the polypropylene has a melt flow rate (“MFR” or melt flow index “MFI”, 230°° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0, in certain embodiments. Suitable grades of polypropylene that are useful in the oriented films described herein include those made by ExxonMobil, LyondellBasell, Total, Borealis, Japan Polypropylene, Mitsui, Sabic, Sibur and other sources.

### Hydrocarbon Resins

Of the numerous resins, hydrocarbon resins are preferred, particularly in the form of petroleum resins, styrene resins, cyclopentadiene resins and terpene resins. These resins are described in Ullmanns Encyklopadie der techn. Chemie [Ullmann's Encyclopedia of Industrial Chemistry], 4th Edition, Volume 12, pages 525 to 555), and that description is incorporated herein by this reference.

The petroleum resins are hydrocarbon resins prepared by polymerization of deep-decomposed petroleum materials in the presence of a catalyst. These petroleum materials usually contain a mixture of resin-forming substances, such as styrene, methylstyrene, vinyltoluene, indene, methylindene, butadiene, isoprene, piperylene and pentylene. The styrene resins are low-molecular-weight homopolymers of styrene or copolymers of styrene with other monomers such as methylstyrene, vinyltoluene and butadiene. The cyclopentadiene resins are cyclopentadiene homopolymers or cyclopentadiene copolymers obtained from coal tar distillates and fractionated petroleum gas. These resins are prepared by keeping the materials containing cyclopentadiene at high temperature for long periods of time. Depending on the reaction temperature, dimers, trimers or oligomers can be obtained.

The terpene resins are polymers of terpenes, i.e., hydrocarbons of the formula C₁₀H₁₆, which are present in virtually all essential oils or oil-containing resins from plants. The terpene resins are also phenol-modified terpene resins. Specific examples of terpenes which may be mentioned are pinene, α-pinene, dipentene, limonene, myrcene, camphene and similar terpenes.

Hydrocarbon resins employed are also styrene homopolymers, styrene copolymers, cyclopentadiene homopolymers, cyclopentadiene copolymers and/or terpene polymers. These hydrocarbon resins have a softening point above about 100° C. (in the case of unsaturated polymers, the hydrogenated product is preferred). Particular preference is given to cyclopentadiene polymers having a softening point of about 140° C. or above in the base layer.

The hydrocarbon resins can also be so-called modified hydrocarbon resins. The modification is generally carried out by reaction of the raw materials before the polymerization, by the introduction of specific monomers or by reaction of the polymerized product, particularly by hydrogenation or partial hydrogenation.

### Skin Layer(s), Including Metallizable Skin Layers and Printable Layers

In some embodiments, the skin layer comprises at least one polymer selected from the group comprising, consisting essentially of, and/or consisting of polypropylene copolymers or terpolymers (e.g., EPB shown in the tables), which may be grafted or copolymerized, and a metallocene based material of either polypropylene or ethylene propylene copolymer.

The skin layer may also comprise processing aid additives, such as anti-block agents, anti-static agents, slip agents and combinations thereof, as discussed herein.

The thickness of the skin layer depends upon the intended function of the skin layer, but is typically in the range of from about 0.20 μm through 3.5 μm, or from 0.30 μm through 2 μm, or in many embodiments, from 0.50 μm through 1.0 μm. In thin film embodiments, the its thickness may range from about 0.20 μm through 1.5 μm, or 0.50 μm through 1.0 μm.

### Additives

Additives present in the film's layer(s) may include, but are not limited to opacifying agents, pigments, colorants, cavitating agents, slip agents, antioxidants, anti-fog agents, anti-static agents, anti-block agents, fillers, moisture barrier additives, gas barrier additives, gas scavengers, and combinations thereof. Such additives may be used in effective amounts, which vary depending upon the property required.

Examples of suitable opacifying agents, pigments or colorants are iron oxide, carbon black, aluminum, titanium dioxide (TiO2), calcium carbonate (CaCO3), and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful is erucamide.

Non-migratory slip agents, used in one or more skin layers of the multilayered films,

may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Useful fillers may include finely divided inorganic solid materials such as silica, fumed silica, diatomaceous earth, calcium carbonate, calcium silicate, aluminum silicate, kaolin, talc, bentonite, clay and pulp.

Optionally, nonionic or anionic wax emulsions can be included in the coating(s), i.e., skin layer(s), to improve blocking resistance and/or lower the coefficient of friction. For example, an emulsion of Michem Lube 215, Michem Lube 160 may be included in the skin layer(s). Any conventional wax, such as, but not limited to Carnauba™ wax (commercially available from Michelman Corporation of Cincinnati, Ohio) that is useful in thermoplastic films is contemplated.

### Metallization

The outer surface (i.e., side facing away from the base) of a skin layer and/or laminating substrate may undergo metallization after optionally being treated. Metallization may be carried out through conventional methods, such as vacuum metallization by deposition of a metal layer such as aluminum, copper, silver, chromium, or mixtures thereof. Following metallization, a coating may be applied to the outer metallized layer “outside” or “inside” the vacuum chamber to result in the following structure: metallized layer/skin layer/optional tie layer/base/optional tie layer/skin layer/metallized layer. In an additional embodiment, a primer may be applied on the metal surface(s) followed by top coating(s).

In certain embodiments, the metal for metallization is metal oxide, any other inorganic materials, or organically modified inorganic materials, which are capable of being vacuum deposited, electroplated or sputtered, such as, for example, SiOx, AlOx, SnOx, ZnOx, IrOx, wherein x=1 or 2, organically modified ceramics “ormocer”, etc. The thickness of the deposited layer(s) is typically in the range from 100 to 5,000 Angstrom or preferably from 300 to 3000 Angstrom.

### Surface Treatment

One or both of the outer surfaces of the multilayered films may be surface-treated to increase the surface energy to render the film receptive to metallization, coatings, printing inks, adhesives, and/or lamination. The surface treatment can be carried out according to one of the methods known in the art including corona discharge, flame, plasma, chemical treatment, or treatment by means of a polarized flame.

### Priming

An intermediate primer coating may be applied to multilayered films. In this case, the film may be first treated by one of the foregoing methods to provide increased active adhesive sites thereon and to the thus-treated film surface there may be subsequently applied a continuous coating of a primer material. Such primer materials include, for example, epoxy, poly (ethylene imine) (PEI), and polyurethane materials. U.S. Pat. Nos. 3,753,769, 4,058,645 and 4,439,493, each incorporated herein by reference, discloses the use and application of such primers. The primer provides an overall adhesively active surface for thorough and secure bonding with the subsequently applied coating composition and can be applied to the film by conventional solution coating means, for example, by roller application.

### Orienting

The films herein are also characterized in certain embodiments as being biaxially oriented. The films can be made by any suitable technique known in the art, such as a tentered or blown process, LISIM™, and others. Further, the working conditions, temperature settings, lines speeds, etc. will vary depending on the type and the size of the equipment used. Nonetheless, described generally here is one method of making the films described throughout this specification. In a particular embodiment, the films are formed and biaxially oriented using the tentered method. In the tentered process, line speeds of greater than 100 m/min to 400 m/min or more, and outputs of greater than 2000 kg/h to 4000 kg/h or more are achievable. In the tenter process, sheets/films of the various materials are melt-blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm. The extruded film is then cooled using air, water, or both. Typically, a single, large diameter roll partially submerged in a water bath, or two large chill rolls set at 20 or 30 to 40 or 50 or 60 or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80 to 100 or 120 or 150° C., in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, but high enough to facilitate the machine direction orientation process. Such temperatures referred to herein refer to the film temperature itself. The film temperature can be measured by using, for example, infrared spectroscopy, the source aimed at the film as it is being processed; those skilled in the art will understand that for transparent films, measuring the actual film temperature will not be as precise. The heating means for the film line may be set at any appropriate level of heating, depending upon the instrument, to achieve the stated film temperatures.

The lengthened and thinned film is passed to the tenter section of the line for TD orientation. At this point, the edges of the sheet are grasped by mechanical clips on continuous chains and pulled into a long, precisely controlled hot air oven for a pre-heating step. The film temperatures range from 100 or 110 to 150 or 170 or 180° C. in the pre-heating step. Again, the temperature will be below that which will melt the film, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the process temperature is lowered by at least 2° C. but typically no more than 20° C. relative to the pre-heat temperature to maintain the film temperature so that it will not melt the film. After stretching to achieve transverse orientation, the film is annealed at a temperature below the melting point, and the film is then cooled from 5 to 10 or 15 or 20 or 30 or 40° C. below the stretching temperature, and the clips are released prior to edge trim, optional coronal, printing and/or other treatment can then take place, followed by winding.

Thus, TD orientation is achieved by the steps of pre-heating the film having been

machine oriented, followed by stretching and annealing it at a temperature below the melt point of the film, and then followed by a cooling step at yet a lower temperature. In one embodiment, the films described herein are formed by imparting a transverse orientation by a process of first pre-heating the film, followed by a decrease in the temperature of the process within the range of from 2 or 3 to 5 to 10 or 15 or 20° C. relative to the pre-heating temperature while performing transverse orientation of the film, followed by a lowering of the temperature within the range of from 5° C. to 10 or 15 or 20 or 30 or 40° C. relative to the melt point temperature, holding or slightly decreasing (more than 5%) the amount of stretch, to allow the film to anneal. The latter step imparts the low TD shrink characteristics of the films described herein. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art know.

Thus, in certain embodiments the film(s) described herein are biaxially oriented with at least a 5 or 6 or 7 or 11-fold TD orientation and at least a 2 or 3 or 7-fold MD orientation. Being so formed, the at least three-layer (one base layer, two skin layers, 18-25 μm thickness) possess an ultimate tensile strength from about 100 or 110 to 80 or 90 or 250 MPa in the TD in some embodiments; and possess an ultimate tensile strength from about 30 or 40 to 150 or 130 MPa in the MD in some embodiments, and/or as otherwise stated herein.

Further example embodiments are provided immediately below.

An oriented shrink film, whether monoaxially or biaxially oriented, may include at least one layer comprising ≥about 5 wt. % through ≤about 95 wt. % of a combination of virgin polypropylene and post-consumer reclaimed polypropylene, wherein filter pressure of the post-consumer reclaimed polypropylene ≤about 50 bar/kg when using a 350-mesh filter on a COLLIN Teach Line Type FT-E20T extruder according to the method and settings in this description, and wherein the oriented shrink film has a shrink value of at least about 5% in at least one direction of orientation, i.e., machine direction, transverse direction, or both the machine and transverse directions. The at least one layer may be in a two-, three-, four-, five-or more-layered film.

The oriented shrink film in the preceding paragraph may have the at least one layer located in the core layer, in one or more tie layer(s), or any combination thereof. Additionally and alternatively, the oriented shrink film may include one or more additives in any its layer(s) or exclude the presence of any additives other than pigments and cavitating agents in any of its layers. Additives may include calcium carbonate, polybutylene terephthalate, or others as previously described in this disclosure. Furthermore, the core layer and/or its tie layer(s) may include one or more plastomers.

The virgin and post-consumer reclaimed polypropylenes of the oriented shrink film in the two preceding paragraphs may be high-crystalline polypropylene, isotactic polypropylene, random polypropylene, PP copolymer, or combinations thereof. And in some examples, the virgin polypropylene in the oriented shrink film comprises at least two, at least three, at least four, or at least five of: random polypropylene, high-crystalline polypropylene, isotactic polypropylene, polypropylene homopolymer, polypropylene copolymer, and polypropylene terpolymer. In some example embodiments, the oriented shrink films either wholly exclude syndiotactic polypropylene or is substantially free of syndiotactic polypropylene.

The oriented shrink film described in any of the three preceding paragraphs may include at least one skin layer comprising a copolymer and/or terpolymer of ethylene, propylene, and/or butylene polymers. In some embodiments, the oriented shrink film may include at least one skin layer comprising a copolymer and/or terpolymer of copolymer or terpolymer comprising carbons from C1-C8, optionally in combination with one or more additives.

The oriented shrink film described in any of the four preceding paragraphs may be a label, i.e., also optionally having the addition of any kind of adhesive to a surface of the oriented shrink film and optionally a liner. Additionally and alternatively, the oriented shrink film may have one or more coatings and/or be metallized.

The oriented shrink film described in any of the five preceding paragraphs may be cast, blown, and/or coextruded.

The at least one layer in the oriented shrink film described in any of the six preceding paragraphs may consist essentially of the post-consumer reclaimed polypropylene and/or consist of the post-consumer reclaimed polypropylene. The “and” in this case in when said oriented shrink film may occur in at least two layers of said oriented shrink film.

The at least one layer in the oriented shrink film described in any of the seven preceding paragraphs results in a stable production, i.e., the oriented shrink film has no web breaks on a BOPP tenter manufacturing tenter line run from about 50 m/min through about 600 m/min at a temperature from about 80° C. through about 180° C., with a web width anywhere between about 1.5 m through about 10 m over a time period of about 1.5 h.

The post-consumer reclaimed polypropylene in the at least one layer in the oriented shrink film described in any of the eight preceding paragraphs may be one or more coated films, one or more metallized films, films, labels, or combinations thereof.

The at least one layer in the oriented shrink film described in any of the nine preceding paragraphs may be transparent, translucent, and/or pigmented.

The at least one layer in the oriented shrink film described in any of the ten preceding paragraphs may include ≤about 20 wt. % hydrocarbon resin(s), or ≤about 15 wt. % hydrocarbon resin(s), or ≤about 10 wt. % hydrocarbon resin(s), wherein such hydrocarbon resin(s) may have a softening point of at least ≤about 150° C., ≤about 140° C., ≤about 130° C., ≤about 120° C., ≤about 110° C., ≤about 100° C., ≤about 90° C., ≤about 80° C., ≤about 70° C., ≤about 60° C., ≤about 50° C., ≤about 40° C., or ≤about 30° C., or any range therebetween said temperatures. In some embodiments, the oriented shrink film may include at least two of said at least one layers described in any of the nine preceding paragraphs, wherein each of these at least one layers also include the HCRs discussed in this paragraph. Additionally and alternatively, said at least one layers described in any of the nine preceding paragraphs may include a hydrocarbon resin in the form of masterbatch hydrocarbon resin(s) in combination or not with at least polypropylene.

The oriented shrink film described in any of the eleven preceding paragraphs may have a core layer that includes the at least one layer described in any of the eleven preceding paragraphs and a plastomer.

The oriented shrink film described in any of the twelve preceding paragraphs may include one or more additives, such as calcium carbonate, polybutylene terephthalate, and/or otherwise.

The oriented shrink film described in any of the thirteen preceding paragraphs may be metallized.

The oriented shrink film described in any of the fourteen preceding paragraphs may have a shrinkage that is substantially homogeneous in a direction of orientation of the oriented shrink film. In some embodiments, the oriented shrink film described in any of the fourteen preceding paragraphs has a shrink value of at least about 10% in the machine direction, the transverse direction, or both the machine and transverse directions.

The oriented shrink film described in any of the fifteen preceding paragraphs may have a total thickness of about ≤25 μm, about ≤50 μm, about ≤75 μm, about ≤100 μm, or any range therebetween any of said total thicknesses.

The oriented shrink film described in any of the sixteen preceding paragraphs may have a Young's Modulus of ≥about 2100 N/mm² in a direction of orientation. And, in some embodiments, the oriented shrink film described in any of the sixteen preceding paragraphs may have a Young's Modulus of ≥about 2100 N/mm² in a machine direction of orientation and/or of ≥about 3500 N/mm² in a transverse direction of orientation.

### INDUSTRIAL APPLICABILITY

The disclosed multilayered films may be stand-alone films, laminates, or webs. Or, the multilayered films may be sealed, coated, metallized, and/or laminated to other film structures. The laminating substrate, itself, may for instance, be a BOPP or a non-oriented, cast or blown PP film or other polymer film with or without the assistance of adhesive(s), increases in temperature and/or pressure, water or solvents, etc.; furthermore, the laminating substrate may or may not be metallized and/or coated. The disclosed multilayered films may be prepared by any suitable methods comprising the steps of co-extruding a multilayered film according to the description and claims of this specification, orienting and preparing the film for intended use such as by coating, printing, slitting, or other converting methods.

For some applications, it may be desirable to laminate the multilayered films to other polymeric film or paper products for purposes such as package decor including printing and metallizing. These activities are typically performed by the ultimate end-users or film converters who process films for supply to the ultimate end-users.

The prepared multilayered film may be used as a flexible packaging film to package an article or good, such as a food item or other product. In some applications, the film may be formed into a pouch type of package, such as may be useful for packaging a beverage, liquid, granular, or dry-powder product.

While the foregoing is directed to example embodiments of the disclosed invention, other and further embodiments may be devised without departing from the basic scope thereof, wherein the scope of the disclosed compositions and methods are determined by one or more claims.

What is claimed is:

1. An oriented shrink film comprising:
at least one layer comprising ≥about 5 wt. % through ≤about 95 wt. % of a combination of virgin polypropylene and post-consumer reclaimed polypropylene,
wherein filter pressure of the post-consumer reclaimed polypropylene ≤about 50 bar/kg when using a 350-mesh filter on a COLLIN Teach Line Type FT-E20T extruder according to the method and settings in the description,
wherein the oriented shrink film has a shrink value of at least about 5% in at least one direction of orientation.

2. The oriented shrink film of claim 1, wherein the at least one layer is a core layer of the oriented shrink film.

3. The oriented shrink film of claim 1, wherein the at least one layer is one or more tie layers of the oriented shrink film.

4. The oriented shrink film of claim 1, wherein the virgin polypropylene comprises high-crystalline polypropylene.

5. The oriented shrink film of claim 1, wherein the virgin polypropylene comprises isotactic polypropylene.

6. The oriented shrink film of claim 1, wherein the virgin polypropylene comprises random polypropylene.

7. The oriented shrink film of claim 1, wherein the virgin polypropylene comprises at least two of random polypropylene, high-crystalline polypropylene, isotactic polypropylene, polypropylene homopolymer, polypropylene copolymer, and polypropylene terpolymer.

8. The oriented shrink film of claim 1, wherein the oriented shrink film excludes syndiotactic polypropylene.

9. The oriented shrink film of claim 1, wherein the oriented shrink film is at least two layers.

10. The oriented shrink film of claim 1, wherein the oriented shrink film is at least four layers.

11. The oriented shrink film of claim 1, wherein the at least one layer further comprises hydrocarbon resin(s), wherein the hydrocarbon resin(s) are present in an amount of ≤about 20 wt. %.

12. The oriented shrink film of claim 1, wherein the oriented shrink film has at least one skin layer comprising a copolymer and/or terpolymer of copolymer or terpolymer comprising carbons from C1-C8, optionally in combination with one or more additives.

13. The oriented shrink film of claim 1, wherein the oriented shrink film comprises a core layer comprising the at least one layer and a plastomer.

14. The oriented shrink film of claim 1, further comprising one or more additives.

15. The oriented shrink film of claim 1, wherein the oriented shrink film is a film.

16. The oriented shrink film of claim 1, wherein the oriented shrink film is a label.

17. The oriented shrink film of claim 1, wherein the at least one layer consists essentially of the post-consumer reclaimed polypropylene.

18. The oriented shrink film of claim 1, wherein the shrink value is at least about 10% in traverse and/or machine direction(s) of orientation.

19. The oriented shrink film of claim 1, wherein the oriented film has a Young's Modulus of ≥about 2100 N/mm² in a direction of orientation.

20. The oriented shrink film of claim 1, wherein the oriented film has a total thickness of less than about 25 μm.
